(19) United States
(12) Patent Application Publication
(10) Pub. No.: US 2006/0282315 A1
(43) Pub. Date: Dec. 14, 2006

(54) Method of marketing and merchandising plants

(75) Inventor: Michelle Brennan, Ontario (CA)

Correspondence Address: KUSNER & JAFFE;HIGHLAND PLACE SUITE 310, 6151 WILSON MILLS ROAD, HIGHLAND HEIGHTS, OH, 44143, US

(73) Assignee: 804935 Ontario Ltd.

(21) Appl. No.: 11/150,971

(22) Filed: Jun. 13, 2005

(51) Int. Cl. G06Q 30/00

(52) U.S. Cl. 705/14

(57) ABSTRACT

The present invention method for the marketing and merchandising of plants involves the personification of one or more plant species with a “personality” or “character” having particular attributes. The one or more personifications are each exemplified by a particular human form. The exemplification thereby enhances promotion and identification of the particular plant species for consideration and purchase by prospective purchasers. Personified plant species including floral plants and their flowers or other plants, are accompanied by a sign bearing the plant species name, a website address, and either an image of the particular human form, the chosen attributes, or both. The sign may also be capable of bearing a description of the plant species, as well as information for care of the plant species, plus a direction to access the website at such address to discover the “personality” or “character” or “attributes” of such personified plant. The website provides a prospective purchaser with plant selection information including via a web-based quiz with online offering process resulting from such quiz results. The website presents a prospective customer with a selection of one or more personified plant species as a consequence of the quiz results where such quiz may be a personality or character recognition quiz or web-based personality test or personal plant preference quiz.

### FIELD OF THE INVENTION

The present invention relates to the field of marketing and merchandising plants by providing plants with a novel promotional sign allied with a method of marketing involving a website.

### BACKGROUND OF THE INVENTION

As a general practice, sellers of plants employ a small, mundane promotional sign with individual plants as an inexpensive means of informing prospective purchasers about the plant species and related plant care. Typically, such signs only display a realistic illustration of the plant species, its name, and some basic plant care information.

Though inexpensive, such signs have achieved varying and unpredictable success as marketing tools. A major disadvantage to this form of advertising is that the plants are promoted inappropriately as mere commodity items, and with no regard for whether the motivation of the prospective purchaser is to acquire a plant or flowers as a gift or for themselves. Such advertising is unattractive so that the information often fails to be noticed by prospective purchasers thereby failing to foster any notable visibility for plants.

Consequently, there is a need in the art for a method of promoting plants as unique, select items for purchase not as commodities, and for enhancing such promotion through the use of a website.

The method of the invention provides a simple solution to suit the wants of the average educated but time-starved prospective purchaser. For non-commodity goods or services, such prospective purchasers want solutions that enable them to acquire items on a simple, yet select, if not custom, basis.

The method represents a method of promotion appealing to and motivating both re-sellers and prospective purchasers. The method consists of the personification of various plant species, accompanied by specific exemplification, and produces a novel and attractive means of promotion and market positioning for such particular plant species. Such promotion is enhanced through the use of a website. Accordingly, unlike any other method of marketing and merchandising plants, the method of the invention allows such prospective purchasers to feel connected to unique and select personified plant species, individually, and as part of a group, and provides a simple understanding of the personification of each plant species. For re-sellers, the method offers a connection with a stylish, new means of promotion that makes plants easier to buy and sell, and offers them the ability to attract more prospective purchasers to their plant retail areas. The method also fosters enhanced goodwill pertaining to such unique, select personified plant species, and enables significant promotion of a large range of plants including less popular plant species to generate interest on the part of prospective purchasers and consequent market acceptance.

The method allows prospective purchasers to feel a sense of connection with the select personified plant species, as it allows them to determine which personified plant species offers a correspondence for them on the basis of one or more attributes. From a re-seller's perspective, the method will attract more prospective purchasers to their retail areas because it offers prospective purchasers a completely new buying experience with the selection based, at least in part, on the unique and attractive personification of one or more plants species. The method represents a simple and innovative solution that will increase sales and attract more prospective purchasers.

### SUMMARY OF THE INVENTION

A method for the marketing and merchandising of plants comprising several steps. These steps include (a) personifying one or more plant species with particular attributes (b) exemplifying each personified plant species with a particular human form, and (c) providing a sign for each personified plant species bearing an image of the particular human form, the plant species name, and a website address. A website is provided and located at the website address, said website being adapted to provide plant selection information via a web-based personality or character recognition quiz or web-based personality test or personal plant preference quiz, and an online offering process resulting from such test results. Such on-line offering process presents a prospective customer with a selection of one or more personified plant species as a consequence of the quiz or test results. Said website may be adapted to provide a prospective purchaser with information and means to order and purchase on-line one or more plants of said one or more personified plant species from a grower, supplier or re-seller of plants of said personified plant species.

### BRIEF DESCRIPTION OF THE DRAWINGS

The present invention may be further understood by reference to the following detailed description of the embodiments of the invention, taken in conjunction with the accompanying drawings, in which:

FIG. 1 is a perspective view of a sign according to an embodiment of the present invention.

FIG. 2 is a perspective view of a sign according to another embodiment of the present invention.

### DETAILED DESCRIPTION OF THE PREFERRED EMBODIMENTS OF THE INVENTION

The description, which follows, and the embodiments described therein, are provided by way of illustration of an example, or examples of particular embodiments of principles and aspects of the present invention. These examples are provided for the purposes of explanation, and not of limitation, of those principles and of the invention. In the description that follows, like parts are marked throughout the specification and the drawings with the same respective reference numerals.

As used herein, “plant” means any plant and their flowers, whether cut or not.

The invention comprises a method for marketing and merchandising plants by enhancing the promotion of particular plant species by personifying one or more plant species and then promoting such personified plant species by reference to said attributes. For example, such personified plant species could include: Phalaenopsis, Calandiva, Bouvardia, Azalea, Gerbera, Cape Angels, Thrysiflora, and Kalanchoe.

More particularly, the method of the invention consists of personifying a plant species with one or more attributes. For clarity, said attributes are not specifically related to plants, as are attributes such as shade tolerance, drought resistance, suitably as a hedge or suitability for certain hardiness zones. Said attributes could include personality traits, or character traits, or traits associated with particular careers or professions or occupations, or characteristics associated with astrology, or characteristics associated with the years of the Chinese calendar. For example, non-plant specific attributes could be selected for Phalaenopsis, such as soulful, intellect, graceful, classy, and mysterious, and for Calandiva, such as playful, modern, colorful, youthful, and endearing, and for Bouvardia, such as stylish, elegant, graceful, classy, and sophisticated, and for Azalea, such as frilly, romantic, delicate, adorable, luxurious, and precocious, and for Kalanchoe, such as hardy, brilliant, pleasant, resilient, and uncomplicated.

The method of the invention can also entail exemplifying said attributes chosen for the personification of said plant species with a particular human form, in whole or in part, real or fictitious. Such human form could entail a face, or head and torso, of a particular gender, with particular attire including attire representative of particular careers or professions or occupations, thereby providing a novel and attractive means of promoting and identifying plant species for consideration and purchase by prospective purchasers.

The method of the invention also entails providing a sign, to accompany an individual plant or group of plants of a particular personified plant species offered for sale, bearing the name of said personified plant species, a specific website address, and either an image of the particular human form corresponding specifically to said personified plant species, or some or all of said attributes, or both. Said sign is also capable of bearing a description about said personified plant species, as well as information for care of said personified plant species. Said sign may be conspicuously placed physically on or adjacent to said individual plant or group of plants.

Said description of said personified plant species may include reference to its shape, height, and spread, its flowers by their shape, size and colour and length of blooming, and its leaves by their shape, size and colour.

Said information for care of said personified plant species may include reference to necessary light, water and feeding as well as appropriate plant hardiness zones.

In addition to the above information, said sign optionally can be provided with additional specific direction for prospective purchasers. For example, a sign according to the invention can recite, “For more information visit www.coolblooms.com”. The sign is typically provided for use at retail stores such as Wal-Mart, superstores, grocery stores, garden centers, or any other retail stores, where plants are offered for sale. Sign can be supplied with direction thereafter to visit the website, to browse information regarding one or more personified plant species for sale. Most preferably, the directions are on the obverse side of the sign. Less preferably, the directions can be provided on the reverse side of the sign or even less preferably on a separate sheet.

Alternatively, the sign can be further provided with a telephone number, email address, or other contact information for those prospective purchasers who wish to contact a grower, supplier or re-seller directly in addition to visiting the website.

The method can also entail providing a website preferably having the specific website address borne by said sign, posting information onto said website consisting of said image, said personified plant species name, and said attributes of each of one or more personified plant species, and adapting said website to permit a prospective purchaser to browse said posted information.

Alternatively, the method entails providing a website having the address for such website promoted to the general consuming public, posting information onto said website consisting of said image, said personified plant species name, and said attributes of each of one or more personified plant species, and adapting said website to permit a prospective purchaser to browse said posted information.

Said posted information on the website can further consist of descriptions of said personified plant species and care information for said personified plant species and suggestions for ornamental display of said personified plant species.

The invention can also entail providing said website with a quiz, adapting said website to permit said prospective purchaser to take said quiz, and adapting said website to present said prospective purchaser with a selection of one or more personified plants as a consequence of the results of said quiz. Said quiz can be a personality recognition quiz or a character recognition quiz or a personality test or a plant preference quiz.

Another principal advantage of a website adapted in this manner is that the website can further promote the sale of one or more personified plant species advertised thereon to prospective purchasers who have not seen a personified plant species sign, and therefore could not be led to the website thereby but have learned of the website otherwise. In this regard, the website can be promoted to the general consuming public via online, television, radio, billboard, or print advertising, leafleting, mass mailing, or via some other known promotional means. Subsequently, a prospective purchaser who learned about the website via some means other than an invention sign, could log onto the website and browse the list of personified plant species in a particular category of information, or take a quiz and thereby obtain a selection of one or more personified plant species having attributes corresponding to the attributes generated by the answers to the quiz.

A website according to the invention is designed such that posted information is then accessible to prospective purchasers who see the sign or other materials promoting the website address and visit the website so indicated. The website prompts prospective purchasers to view the information pertaining to one or more personified plants species the prospective purchaser may have seen advertised by one or more of said signs, or otherwise, or to browse the information pertaining to one or more personified plant species accessible to such prospective purchasers on the website.

A website according to the invention may also provide the prospective purchasers with contact information (such as phone number and e-mail address) of the re-seller so the purchaser can contact the re-seller and arrange to consummate a purchase transaction, including paying the purchase price and picking up the plant.

A website according to the invention having either posted information or provided with said quiz may be adapted further to facilitate an e-commerce transaction by providing a prospective purchaser with information and means to order and purchase on-line one or more plants of said one or more personified plant species from a grower, supplier or re-seller of plants of said personified plant species.

The promotion of the personified plant species can be also be effected through known retail merchandising techniques including in-store signs, point-of-purchase displays, shelf signs, the use of slogans specific to the personified plant species, etc.

In addition or alternatively, promotional materials for specific personified plant species can be designed to present an independent but overall consistent appearance. Materials featuring each personified plant species will fit an appearance specific to its type, and will represent that which makes that each specific personified plant species unique. This approach allows reinforcement of each specific personified plant species as its own distinctive plant species, while maintaining visual loyalty to an overall appearance for such specific personified plant species.

The personified plant species will be uniquely attractive whether through the use of said sign, or other promotion of the website address, that lead the prospective purchaser to a website permitting the prospective purchaser to browse posted information concerning one or more personified plant species or take a quiz to obtain a selection of one or more personified plant species available for sale with attributes that correspond to attributes generated by the answers to the quiz.

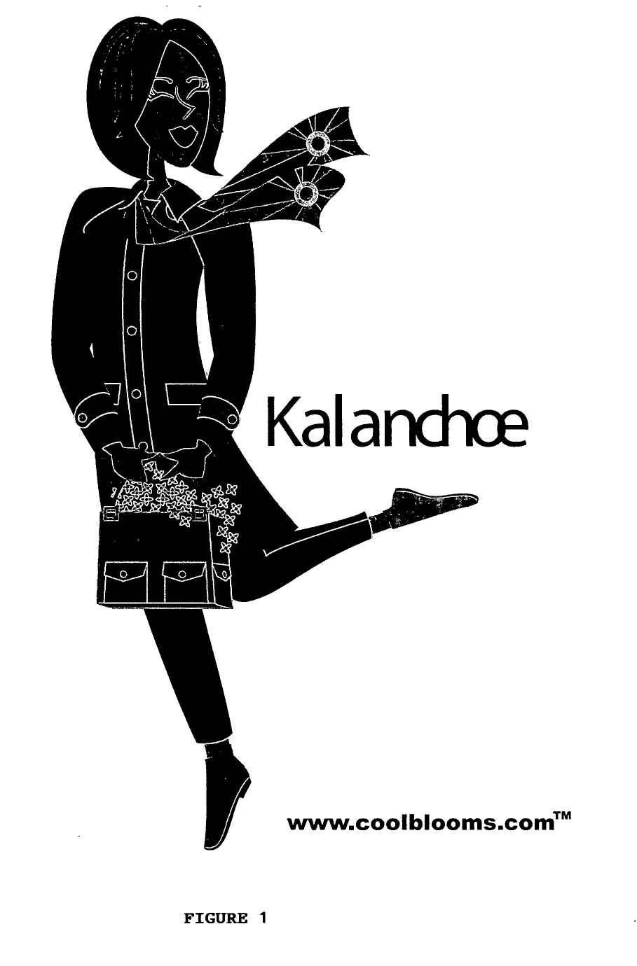

For example, referring to FIG. 1, according to a first embodiment, a sign is provided with an image of a fictitious female human attired in a dress, the name of the particular personified plant species, and a website address, www.coolblooms.com, at which website address a prospective purchaser can take a quiz and obtain a selection of personified plant species for possible purchase.

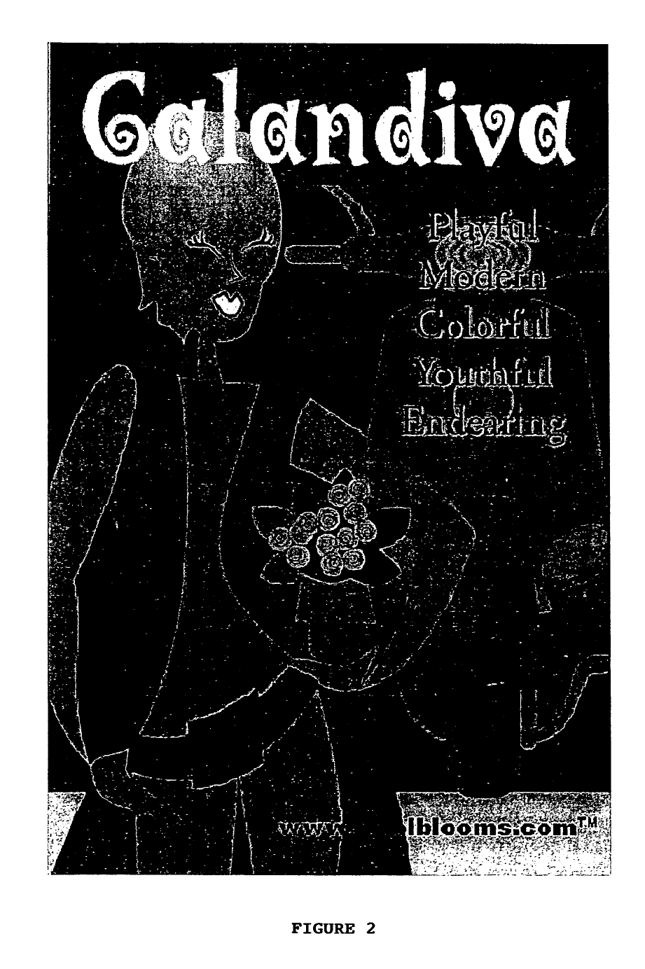

Referring to FIG. 2, and according to a second embodiment of the present invention, a sign is provided with an image of a fictitious female human attired in a dress, the name of the personified plant species, and one or more of said attributes corresponding specifically to the particular personified plant species, and a website address, www.coolblooms.com, at which website address a prospective purchaser can take a quiz and obtain a selection of personified plant species for possible purchase.

Though the sign of FIG. 1 is for the plant species, Kalanchoe, and the sign of FIG. 2 is for the plant species, Calandiva, obviously, other plant species can be marketed using a sign according to the invention as shown in FIG. 1 or FIG. 2 such as Phalaenopsis, Bouvardia, Azaleas, or Cape Angels.

FIGS. 1 and 2 show the image of the particular human form exemplifying a particular personified plant species, plus the name of the particular personified plant species, and the website address, www.coolblooms.com, on the sign, that is, when the re-seller purchases a stock of plants of one or more personified plant species, and the corresponding signs, such information is already on the signs provided by the supplier of the plants and signs.

The one or more personified plant species will be uniquely attractive and easily identifiable through the use of an image of a specific human form to exemplify the personified plant species personified by chosen attributes.

In addition to allowing prospective purchasers to view information specific to a particular personified plant species by reference to its unique image, or take a quiz and thereby obtain a selection of one or more personified plant species, a website according to the invention can also be advantageously adapted to allow prospective purchasers to browse all information as to available personified plant species within a particular category such as by plant description or care information. A website adapted in this manner has a principal advantage that it does not require prospective purchasers to recall the image on a sign which they have previously seen. Instead, having seen a sign advertising a personified plant species, for example, a prospective purchaser could log onto the website and browse a list of one or more personified plant species for sale by reference to a category of information such as plant hardiness zone encompassing the location where the prospective purchaser wishes to grow the plant. It will be understood that an attractive, intuitive website address, such as “www.coolblooms.com”, will more likely be recalled by a prospective purchaser in a hurry than a random set of numbers or letters.

A marketing system according to the invention represents a unique development in the marketing of plants because it uniquely links a prospective purchaser directly to an e-commerce transaction. By directing prospective purchasers to an Internet website, to obtain information about particular plant species and then order and purchase a particular plant species for sale, the sign of the present invention directly facilitates an e-commerce transaction.

Although the above description and accompanying drawings relate to specific preferred embodiments of the present invention as presently contemplated by the inventor, it will be understood that various changes, modifications and adaptations may be made without departing from the spirit of the invention.

The embodiments of the invention in which an exclusive property or privilege is claimed are defined as follows:

1. A method for marketing and merchandising plants by enhancing the promotion of particular plant species consisting of the following steps:
a) personifying one or more plant species with one or more non-plant specific attributes;
b) providing one or more physical signs, to accompany an individual plant, or group plants of said one or more personified plant species, offered for sale, bearing the name of the particular personified plant species, and one or more of said attributes corresponding specifically to the particular personified plant species; and
c) conspicuously placing said one or more signs physically on or adjacent to said plant or group of plants.

2. A method for marketing and merchandising plants by enhancing the promotion of particular plant species consisting of the following steps:
a) personifying one or more plant species with one or more non-plant specific attributes;
b) exemplifying each such personification of plant species with a particular human form, in whole or in part, real or fictitious;
c) providing one or more physical signs, to accompany an individual plant, or group plants of said one or more personified plant species, offered for sale, bearing the name of the particular personified plant species, and an image of the particular human form corresponding specifically to the particular personified plant species; and
d) conspicuously placing said one or more signs physically on or adjacent to said plant or group of plants.

3. A method for marketing and merchandising plants by enhancing the promotion of particular plant species consisting of the following steps:
a) personifying one or more plant species with one or more non-plant specific attributes;
b) exemplifying each such personification of plant species with a particular human form, in whole or in part, real or fictitious;
c) providing one or more physical signs, to accompany an individual plant, or group plants of said one or more personified plant species, offered for sale, bearing the name of the particular personified plant species, an image of the particular human form corresponding specifically to the particular personified plant species; and one or more of said attributes corresponding specifically to the particular personified plant species; and
d) conspicuously placing said one or more signs physically on or adjacent to said plant or group of plants.

4. A method according to claim 3, wherein said one or more signs include in-store signs such as point-of-purchase displays, shelf signs, aisle or area signs.

5. A method according to claim 3, wherein at least one of said one or more signs is provided with a description of the particular personified plant species.

6. A method according to claim 3, wherein at least one of said one or more signs is provided with care information for the particular personified plant species.

7. A method according to claim 3, wherein the promotion of said one or more personified plant species consists of the following steps:
a) providing a website having a website address;
b) at least one of said one or more signs also bearing said website address;
c) posting information onto said website, consisting of the names of the one or more personified plant species, images of the particular human form corresponding specifically to the one or more personified plant species; and one or more of said attributes corresponding specifically to the one or more personified plant species; and
d) adapting said website to permit a prospective purchaser to browse said posted information.

8. A method according to claim 7, further comprising the following steps:
a) providing said website with a quiz;
b) adapting said website to permit said prospective purchaser to take said quiz; and
c) adapting said website to present said prospective purchaser with a selection of one or more personified plants as a consequence of the results of said quiz.

9. A method according to claim 7, further comprising the steps:
a) adapting said website to provide a prospective purchaser with information relating to ordering one or more plants of said one or more personified plant species and concluding a contract to purchase one or more plants of said one or more personified plant species from a grower, supplier or re-seller of plants of said one or more personified plant species, and
b) adapting said website to permit said prospective purchaser to order online one or more plants of said one or more personified plant species and conclude online a contract to purchase one or more plants of said one or more personified plant species from a grower, supplier or re-seller of plants of said one or more personified plant species.

10. A method according to claim 8, further comprising the following steps:
a) adapting said website to provide a prospective purchaser with information relating to ordering one or more plants of said one or more personified plant species and concluding a contract to purchase one or more plants of said one or more personified plant species from a grower, supplier or re-seller of plants of said one or more personified plant species, and
b) adapting said website to permit said prospective purchaser to order online one or more plants of said one or more personified plant species and conclude online a contract to purchase one or more plants of said one or more personified plant species from a grower, supplier or re-seller of plants of said one or more personified plant species.

11. A method according to claim 8, wherein said quiz is a personality recognition quiz or a character recognition quiz or a personality test or a plant preference quiz.

12. A method according to claim 7, wherein said posted information further consists of descriptions of said one or more personified plant species.

13. A method according to claim 8, wherein said posted information further consists of descriptions of said one or more personified plant species.

14. A method according to claim 9, wherein said posted information further consists of descriptions of said one or more personified plant species.

15. A method according to claim 10, wherein said posted information further consists of descriptions of said one or more personified plant species.

16. A method according to claim 12, wherein said posted information further comprises care information for said one or more personified plant species.

17. A method according to claim 13, wherein said posted information further comprises care information for said one or more personified plant species.

18. A method according to claim 14, wherein said posted information further comprises care information for said one or more personified plant species.

19. A method according to claim 15, wherein said posted information further comprises care information for said one or more personified plant species.

20. A method according to claim 16 wherein said posted information further comprises suggestions for ornamental display of said one or more personified plant species.

21. A method according to claim 17, wherein said posted information further comprises suggestions for ornamental display of said one or more personified plant species.

22. A method according to claim 18, wherein said posted information further comprises suggestions for ornamental display of said one or more personified plant species.

23. A method according to claim 19, wherein said posted information further comprises suggestions for ornamental display of said one or more personified plant species.

24. A method according to claim 7, wherein said posted information further consists of contact information for a grower or supplier or re-seller one or more plants of the one or more personified plant species.

25. A method according to claim 8, wherein said posted information further consists of contact information for a grower or supplier or re-seller one or more plants of the one or more personified plant species.

26. A method according to claim 9, wherein said posted information further consists of contact information for a grower or supplier or re-seller one or more plants of the one or more personified plant species.

27. A method according to claim 10, wherein said posted information further consists of contact information for a grower or supplier or re-seller one or more plants of the one or more personified plant species.

28. A method for marketing and merchandising plants by enhancing the promotion of particular plant species consisting of the following steps:
a) personifying one or more plant species with one or more non-plant specific attributes;
b) providing a website having a website address;
c) promoting said website address to the general consuming public via online, television, radio, billboard, or print advertising, or some other known promotional means with a direction to visit said website address;
d) posting information onto said website, consisting of the names of the one or more personified plant species, and an indication that one or more plant species possess one or more non-plant specific attributes; and
e) adapting said website to permit a prospective purchaser to browse said posted information.

29. A method for marketing and merchandising plants by enhancing the promotion of particular plant species consisting of the following steps:
a) personifying one or more plant species with one or more non-plant specific attributes;
b) exemplifying each such personification of plant species with a particular human form, in whole or in part, real or fictitious;
c) providing a website having a website address;
d) promoting said website address to the general consuming public via online, television, radio, billboard, or print advertising, or some other known promotional means with a direction to visit said website address;
e) posting information onto said website, consisting of the names of the one or more personified plant species, and an image of a particular human form, in whole or in part, real or fictitious, corresponding specifically to each said one or more plant species; and
f) adapting said website to permit a prospective purchaser to browse said posted information.

30. A method for marketing and merchandising plants by enhancing the promotion of particular plant species consisting of the following steps:
a) personifying one or more plant species with one or more non-plant specific attributes;
b) exemplifying each such personification of plant species with a particular human form, in whole or in part, real or fictitious;
c) providing a website having a website address;
d) promoting said website address to the general consuming public via online, television, radio, billboard, or print advertising, or some other known promotional means with a direction to visit said website address;
e) posting information onto said website, consisting of the names of the one or more personified plant species, an image of a particular human form, in whole or in part, real or fictitious, corresponding specifically to each said one or more plant species, and an indication that one or more plant species possess one or more non-plant specific attributes; and
f) adapting said website to permit a prospective purchaser to browse said posted information.

31. A method according to claim 28, further comprising the following steps:
a) adapting said website to provide a prospective purchaser with information relating to ordering one or more plants of said one or more personified plant species and concluding a contract to purchase one or more plants of said one or more personified plant species from a grower, supplier or re-seller of plants of said one or more personified plant species, and
b) adapting said website to permit said prospective purchaser to order online one or more plants of said one or more personified plant species and conclude online a contract to purchase one or more plants of said one or more personified plant species from a grower, supplier or re-seller of plants of said one or more personified plant species.

32. A method according to claim 29, further comprising the following steps:
a) adapting said website to provide a prospective purchaser with information relating to ordering one or more plants of said one or more personified plant species and concluding a contract to purchase one or more plants of said one or more personified plant species from a grower, supplier or re-seller of plants of said one or more personified plant species, and
b) adapting said website to permit said prospective purchaser to order online one or more plants of said one or more personified plant species and conclude online a contract to purchase one or more plants of said one or more personified plant species from a grower, supplier or re-seller of plants of said one or more personified plant species.

33. A method according to claim 30, further comprising the following steps:
a) adapting said website to provide a prospective purchaser with information relating to ordering one or more plants of said one or more personified plant species and concluding a contract to purchase one or more plants of said one or more personified plant species from a grower, supplier or re-seller of plants of said one or more personified plant species, and
b) adapting said website to permit said prospective purchaser to order online one or more plants of said one or more personified plant species and conclude online a contract to purchase one or more plants of said one or more personified plant species from a grower, supplier or re-seller of plants of said one or more personified plant species.
